(19) United States
(12) Patent Application Publication
(10) Pub. No.: US 2026/0126525 A1
(43) Pub. Date: May 7, 2026

(54) DETECTION AND CLASSIFICATION OF TUNNELS USING LIDAR

(71) Applicant: GM GLOBAL TECHNOLOGY OPERATIONS LLC, Detroit, MI (US)

(72) Inventors: Siva CHINTHALAPUDI, Novi, MI (US); Brent Navin Roger BACCHUS, Sterling Heights, MI (US); Thanura ELVITIGALA, Frisco, TX (US)

(21) Appl. No.: 18/935,053

(22) Filed: Nov. 1, 2024

(51) Int. Cl. G01S 7/48; G01S 7/487; G01S 17/931

(52) U.S. Cl. CPC G01S 7/4802; G01S 7/4876; G01S 17/931

(57) ABSTRACT

A driver assistance system includes a light detection and ranging (LiDAR) sensor. A detecting module is configured to detect tunnels in a path of the vehicle. The detecting module includes a zoning module configured to bin the returns from the LiDAR sensor into a plurality of zones. A clustering and feature extraction module is configured to identify clusters in the zones, determine centers and variances of the clusters in x-axis, y-axis, and z-axis directions in the plurality of zones, identify a plurality of features based on the centers and the variances of the clusters, and concatenate the plurality of features into one or more concatenated features. A classification module is configured to receive the one or more concatenated features and to declare at least one of an approaching state, an inside state, and a clear state for a tunnel in response to the one or more concatenated features.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to driver assistance systems, and more particularly to driver assistance systems including light detection and ranging (LiDAR) sensors.

Vehicles including various levels of driver assistance (such as fully or partially autonomous vehicles) often rely on radio detection and ranging (radar) systems to detect and avoid objects in the path of the vehicle. Radar-based systems experience problems detecting objects when the vehicle is travelling through tunnels (or other similar infrastructure such as under overpasses). For example, radar-based systems detect ghost objects and/or errant tracks caused by tunnel infrastructure when moving through tunnels.

### SUMMARY

A driver assistance system for a vehicle includes a light detection and ranging (LiDAR) sensor configured to transmit light pulses and to receive returns. A detecting module is configured to detect tunnels in a path of the vehicle. The detecting module includes a zoning module configured to bin the returns from the LiDAR sensor into a plurality of zones. The detecting module includes a clustering and feature extraction module configured to identify clusters in the zones, determine centers and variances of the clusters in x-axis, y-axis, and z-axis directions in the plurality of zones, identify a plurality of features based on the centers and the variances of the clusters, and concatenate the plurality of features into one or more concatenated features. A classification module is configured to receive the one or more concatenated features and to declare at least one of an approaching state, an inside state, and a clear state for a tunnel in response to the one or more concatenated features.

In other features the plurality of zones include a first zone and a second zone. The first zone corresponds to the returns from the LiDAR sensor with values in the z-axis direction that are less than a predetermined height. The second zone corresponds to the returns with values in the z-axis direction greater than the predetermined height. The driver assistance system includes a global position system (GPS). The LiDAR sensor converts the returns into a Fernet frame in response to data from the GPS system.

In other features, an inertial measurement system is configured to detect a pitch of the vehicle, wherein the LiDAR sensor compensates the returns in response to the pitch of the vehicle. The classifier module includes a pre-trained model configured to detect the approaching state, the inside state, and the clear state in response to the one or more concatenated features. A filter module is configured to filter an output of the classifier module using a Hidden Markov Model. The Hidden Markov Model filters out infeasible state transitions.

In other features, the pre-trained model is configured to detect the approaching state in response to the variances of the clusters in the x-axis direction in the second zone being less than a first variance and the variances of the clusters in the z-axis direction in the second zone being greater than a second variance and the inside state in response to the variances of the clusters in the x-axis direction in the second zone being greater than a third variance and the variances of the clusters in the z-axis direction in the second zone being less than a fourth variance, wherein the first variance is less than the third variance and the third variance is greater than the fourth variance.

In other features, the classifier module is configured to detect a wall in a path of the vehicle in response to the variances of the clusters in the x-axis direction and the z-axis direction.

A method for assisting a driver of for a vehicle includes transmitting light pulses and to receive returns using a light detection and ranging (LiDAR) sensor; binning the returns from the LiDAR sensor into a plurality of zones; identifying clusters in the zones; determining centers and variances of the clusters in x-axis, y-axis, and z-axis directions in the plurality of zones; identifying a plurality of features based on the centers and the variances; concatenating the plurality of features into one or more concatenated features; and detecting at least one of an approaching state, an inside state, and a clear state for a tunnel in response to the one or more concatenated features.

In other features, the plurality of zones include a first zone and a second zone. The first zone corresponds to the returns from the LiDAR sensor with values in the z-axis direction less than a predetermined height and the second zone corresponds to the returns with values in the z-axis direction greater than the predetermined height.

In other features, the method includes converting the returns into a Fernet frame. The method includes detecting pitch of the vehicle; and compensating the returns from the LiDAR sensor in response to the pitch of the vehicle.

In other features, the method includes using a pre-trained model to detect the approaching state, the inside state, and the clear state in response to the one or more concatenated features. The method includes filtering an output of the pre-trained model using a Hidden Markov Model. The Hidden Markov Model filters out infeasible state transitions.

In other features, the pre-trained model is configured to detect the approaching state in response to the variances of the clusters in the x-axis direction in the second zone being less than a first variance and the variances of the clusters in the z-axis direction in the second zone being greater than a second variance; and the inside state in response to the variances of the clusters in the x-axis direction in the second zone being greater than a third variance and the variances of the clusters in the z-axis direction in the second zone being less than a fourth variance, wherein the first variance is less than the third variance and the third variance is greater than the fourth variance.

In other features, the pre-trained model is configured to detect a wall in a path of the vehicle in response to the variances in the x-axis direction and the z-axis direction.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of a vehicle including a driver assistance controller, a tunnel detecting system, an autonomous driving module, a global positioning system (GPS), and a light detection and ranging (LiDAR) sensor according to the present disclosure;

FIG. 2 illustrates an orientation of a vehicle relative to a coordinate system;

FIGS. 3A to 3C illustrate LIDAR return data for a vehicle traveling towards a tunnel opening, a vehicle in a tunnel, and a vehicle traveling towards a wall, respectively, according to the present disclosure;

FIG. 4 illustrates states and transitions of a Hidden Markov Model used to reduce noise and eliminate infeasible state transitions; and

FIG. 5A and 5B are flowcharts of a method for identifying tunnels using LIDAR sensor according to the present disclosure.

In the drawings, reference numbers may be reused to identify similar and/or identical elements.

### DETAILED DESCRIPTION

To mitigate these errors, some radar-based systems attempt to detect tunnels prior to entering the tunnels. Due to sensor limitations, however, the radar-based systems are not able to accurately detect the tunnels. The radar-based systems experience a high number of false detections despite the absence of infrastructure/tunnels and a large percentage of target misses when traveling through the tunnels.

The tunnel detecting system according to the present disclosure uses return data from a light detection and ranging (LiDAR) sensor to detect tunnels for a driver assistance controller. LiDAR sensors have a high resolution, high precision, and accuracy as compared to typical radar systems. Utilizing LiDAR sensors to detect tunnels more accurately reduces false braking caused by errant radar returns.

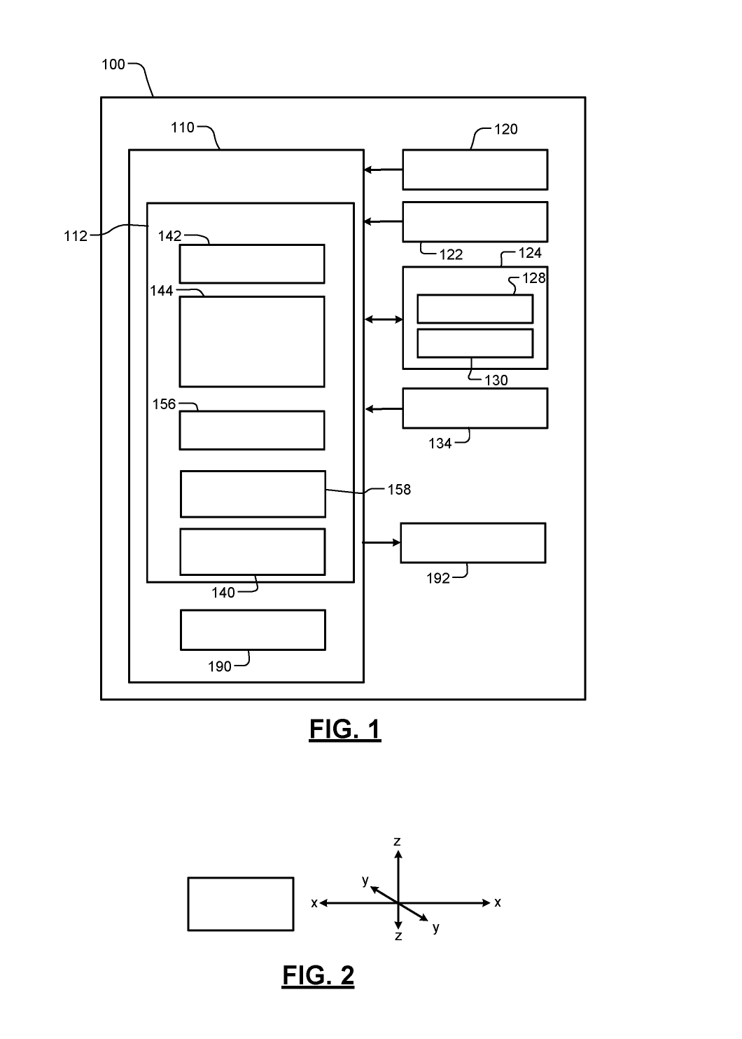

Referring now to FIGS. 1 to 3C, operation of a tunnel detecting module 112 is shown. In FIG. 1, a vehicle 100 includes a driver assistance controller 110 including a tunnel detecting module 112 and an autonomous driving module 190 supporting full or partial autonomous driving levels. A global positioning system 120 determines a position of the vehicle and outputs the vehicle position and steering path to the driver assistance controller 110. A radar system 122 optionally generates radio frequency (RF) pulses and outputs radar return signals to the driver assistance controller 110.

A LiDAR sensor 124 generates light pulses and outputs return signals to the driver assistance controller 110. In some examples, the LiDAR sensor 124 includes one or more lasers 130. In some examples, the LiDAR sensor 124 includes one or more scanners 128 that scan the one or more lasers 130 in a steering path or a field of view of the vehicle.

An inertial measurement unit (IMU) 134 generates yaw and pitch data for the vehicle and outputs the yaw and pitch to the driver assistance controller 110. The return data from the LiDAR sensor 124 is converted into a Fernet frame using data from the GPS 120 (and/or the pitch and/or yaw of the vehicle from the IMU 134). The returns are stored in a point cloud that is converted to ego motion in a Fernet frame using a center of the road (expressed in terms of distance along a road center and perpendicular offset) to account for a steering path of the vehicle and improve accuracy.

The tunnel detecting module 112 is configured to detect when a lip or entrance to a tunnel is in the path of the vehicle (corresponding to a tunnel approaching state). The tunnel detecting module 112 is configured to detect when the vehicle is in the tunnel (corresponding to an inside state), walls in the path of the vehicle, and/or when the vehicle is clear from the tunnel (corresponding to a clear state). The tunnel detecting module 112 includes LiDAR return data storage 140 to store return points from the LiDAR sensor 124 (e.g., LiDAR point cloud data).

The tunnel detecting module 112 includes a zoning module 142 configured to bin the returns from the LiDAR sensor into a plurality of spatial regions or zones. A clustering and feature extraction module 144 is configured to identify clusters (or groups of returns) in the plurality of zones. The clustering and feature extraction module 144 is configured to determine centers and variances of the clusters in x-axis, y-axis, and z-axis directions in the plurality of zones. The clustering and feature extraction module 144 is configured to identify a plurality of features based on the centers and the variances. The clustering and feature extraction module 144 is configured to concatenate the plurality of features into one or more concatenated features.

In some examples, the plurality of zones include a first zone and a second zone. The first zone corresponds to returns having values in the z-axis direction that are less than a predetermined height. The second zone corresponds to returns having values in the z-axis direction that are greater than the predetermined height. In some examples, an output of the IMU 134 is used to make corrections for changes in vehicle pitch and/or yaw and to increase accuracy. Use of the data from the IMU 134 allows detection of tunnels with sloped entrances.

In some examples, the clustering and feature extraction module 144 outputs the one or more concatenated features to a classifier module 156. The classifier module 156 use a pre-trained model to determine whether the one or more concatenated features correspond to a lip of a tunnel (e.g., signifying an approaching state), the vehicle being inside of a tunnel (an inside state), a wall in a tunnel (and in the path of the vehicle), or clear of a tunnel (or a clear state).

A filter module 158 receives an output of the classifier and uses a Hidden Markov model having predefined states and transitions. The Hidden Markov Model reduces noise by eliminating infeasible state transitions. For example, each of the states may have only certain transitions to other states. For example, the clear state cannot be followed by the inside state. In some examples, the clear state can be followed by another clear state or the approaching state, the approaching state can be followed by another approaching state or the inside state, and the inside state can be followed by another inside state or the clear state.

In some examples, the driver assistance controller 110 includes an autonomous driving module 190 configured to control one or more vehicle control inputs 192 such as a steering wheel or steering input, accelerator pedal or propulsion input, vehicle speed, brake pedal or braking input, turn signals, etc.

In FIG. 2, the vehicle is shown relative to the x-axis direction (e.g., direction of forward movement), the y-axis direction (e.g., direction of lateral movement), and z-axis direction (e.g., height direction).

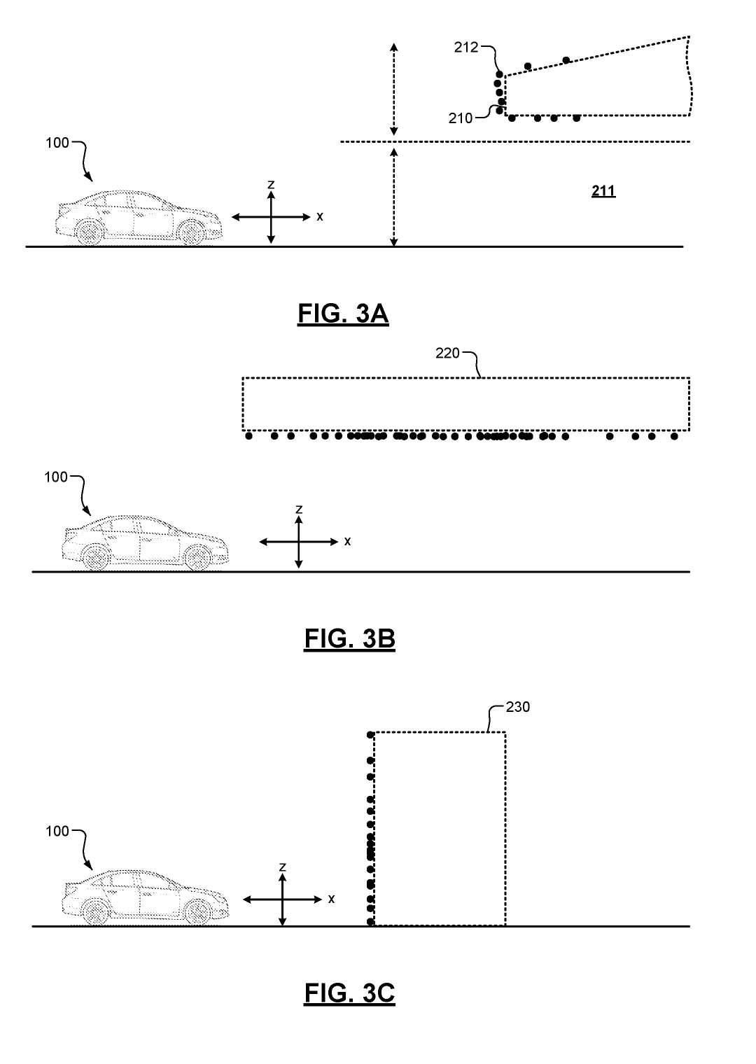

In FIG. 3A, the two or more zones include a first zone (zone 1) including z-axis data (e.g., FIG. 2) in a first predetermined range and a second zone (zone 2) including z-axis data in a second predetermined range. In some examples, the first zone includes z-axis values in a range from 0 to 10 feet and the second zone includes z-axis values in a range from 10 to 18 feet. In other examples, the first zone includes z-axis values in a range from 0 to 14 feet and the second zone includes z-axis values in a range from 14 to 18 feet.

The tunnel detecting module 112 includes a clustering and feature extracting module 144 that analyzes the data in the zones. The clustering and feature extracting module 144 identifies clusters of LiDAR returns within each zone. The clustering and feature extracting module 144 identifies centers of the clusters and calculates variances within the clusters in x, y, and z directions (FIG. 2) for each of the zones.

The tunnel detecting module 112 includes a concatenating module 152 that concatenates the features and outputs the concatenated features to a classifier module 156. In some examples, the classifier module 156 includes a pre-trained model that analyzes and classifies the concatenated features output by the concatenating module 152.

For example, the tunnel detecting module 112 extracts features using zoning or binning corresponding to areas where tunnel features are typically found. Binning lessens the amount of computation that is required. For example, the data is separated into two distinct spatial regions (e.g., the z axis is split into two zones (e.g., corresponding to 0 to 10 ft and 10 to 18 ft). Following the identification of clusters in the region, the variance in the x, y, and z directions within each cluster are classified.

In FIG. 3A, a lip or entrance 210 into a tunnel 211 corresponds to a first classification of the classifier module 156. The classifier module 156 searches for statistical traits corresponding to the lip or entrance 210 of the tunnel 211. In some examples, the classifier module 156 searches the second zone (Zone 2) corresponding to a range between 10 and 18 ft. The classifier module 156 identifies the lip or entrance 210 when the variance of return points 212 corresponds to a low spread along the x-axis and higher spread in the z axis. In some examples, the tunnel detecting module 112 sets a first flag when the lip or entrance is identified.

In FIG. 3B, a second classification corresponds to the vehicle being located inside of the tunnel 211. The second classification of the classifier module 156 corresponds to return points 212 have a low spread in the z-axis and higher spread in the x-axis (corresponding to returns from the ceiling of the tunnel). In some examples, the tunnel detecting module 112 sets a second flag when the vehicle detects the tunnel within steering path of the vehicle.

In FIG. 3C, a third classification of the classifier module 156 corresponds to situations when the vehicle has a wall 230 in a path of the vehicle or within the field of view. Attempting to identify the third classification may be initiated after the first classification identifies the lip or entrance of the tunnel. The third classification corresponds to low spread in the x-axis and higher spread in the z-axis. In some examples, the third classification includes both zones (e.g., from 0 to 18 ft spread).

A fourth classification of the classifier module 156 corresponds to a clear state when there are significantly fewer or no returns in the path of the vehicle or in the field of view.

In some examples, the tunnel detecting module 112 uses a Hidden Markov Model. The hidden Markov model includes a clear state, an approaching state, and an inside state. In some examples, state transitions of the Hidden Markov Model are limited to Clear ---> Approaching ---> Inside ---> Clear.

In FIG. 4, a clear state 410 of the Hidden Markov Model indicates that there is no tunnel (the tunnel detection flag has not been set). An approaching state 414 begins when the tunnel detecting module 112 detects the lip or entrance 210 of the tunnel 211. After the approaching state 414 is declared, the tunnel detecting module 112 determines whether the vehicle is inside of the tunnel 211 and, if true, the tunnel detecting module transitions to an inside state 418. After transitioning to the inside state 418, the tunnel detecting module 112 transitions to the clear state 410 when there are no returns within the field of view.

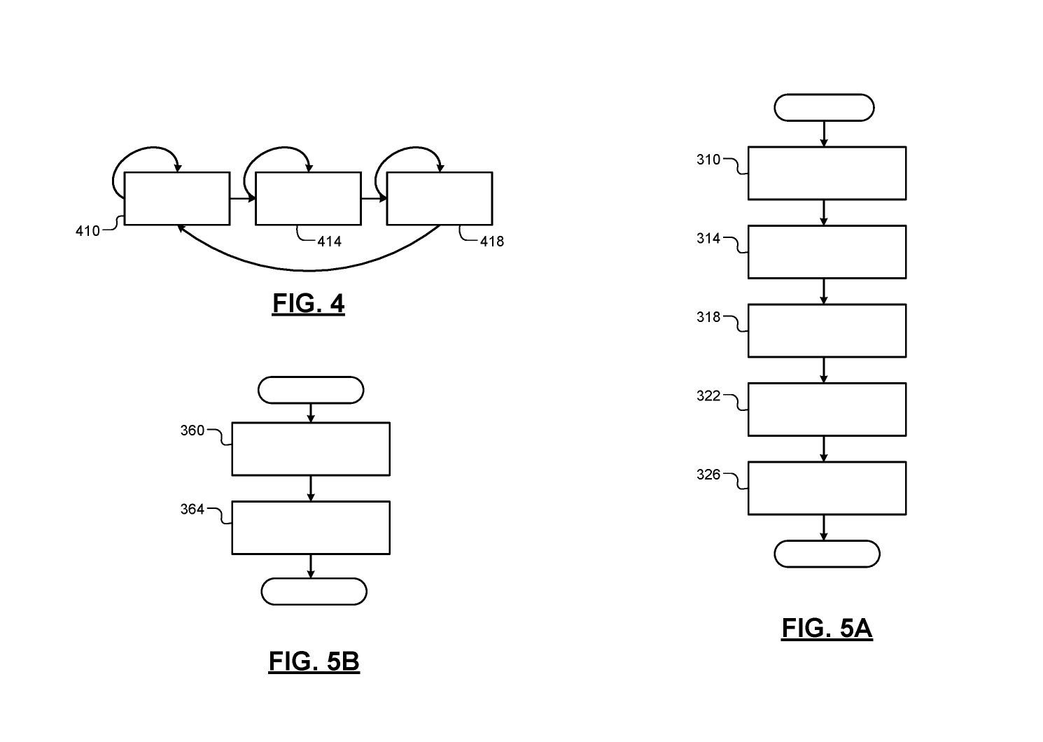

Referring now to FIG. 5A, a method for detecting tunnels is shown. At 310, the LiDAR sensor generates light pulses and receives return points. The LiDAR sensor also receives GPS data and locates the return points in a path or a field of view of the vehicle. At 314, the return points or returns are collected into bins or zones. At 318, features are extracted from the zones. At 322, the features are concatenated. At 326, a classifier uses a model such as a pre-trained machine learning model to identify when the vehicle approaches a tunnel, is in the tunnel, or clears the tunnel.

Referring now to FIG. 5B, a method for extracting features from the zones is shown. At 360, clusters are identified in each of the zones. At 364, the centers and variances of the clusters are determined in x, y, and z directions.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A driver assistance system for a vehicle, comprising:
a light detection and ranging (LiDAR) sensor configured to transmit light pulses and to receive returns; and
a detecting module configured to detect tunnels in a path of the vehicle including:
a zoning module configured to bin the returns from the LiDAR sensor into a plurality of zones;
a clustering and feature extraction module configured to:
identify clusters in the zones,
determine centers and variances of the clusters in x-axis, y-axis, and z-axis directions in the plurality of zones,
identify a plurality of features based on the centers and the variances of the clusters, and
concatenate the plurality of features into one or more concatenated features; and
a classification module configured to receive the one or more concatenated features and to declare at least one of an approaching state, an inside state, and a clear state for a tunnel in response to the one or more concatenated features.

2. The driver assistance system of claim 1, wherein the plurality of zones include a first zone and a second zone.

3. The driver assistance system of claim 2, wherein the first zone corresponds to the returns from the LiDAR sensor with values in the z-axis direction that are less than a predetermined height and the second zone corresponds to the returns with values in the z-axis direction greater than the predetermined height.

4. The driver assistance system of claim 1, further comprising a global position system (GPS), wherein the LiDAR sensor converts the returns into a Fernet frame in response to data from the GPS system.

5. The driver assistance system of claim 4, further comprising an inertial measurement system configured to detect a pitch of the vehicle, wherein the LiDAR sensor compensates the returns in response to the pitch of the vehicle.

6. The driver assistance system of claim 3, wherein the classifier module includes a pre-trained model configured to detect the approaching state, the inside state, and the clear state in response to the one or more concatenated features.

7. The driver assistance system of claim 6, further comprising a filter module configured to filter an output of the classifier module using a Hidden Markov Model.

8. The driver assistance system of claim 7, wherein the Hidden Markov Model filters out infeasible state transitions.

9. The driver assistance system of claim 6, wherein the pre-trained model is configured to detect:
the approaching state in response to the variances of the clusters in the x-axis direction in the second zone being less than a first variance and the variances of the clusters in the z-axis direction in the second zone being greater than a second variance; and
the inside state in response to the variances of the clusters in the x-axis direction in the second zone being greater than a third variance and the variances of the clusters in the z-axis direction in the second zone being less than a fourth variance, wherein the first variance is less than the third variance and the third variance is greater than the fourth variance.

10. The driver assistance system of claim 1, wherein the classifier module is configured to detect a wall in a path of the vehicle in response to the variances of the clusters in the x-axis direction and the z-axis direction.

11. A method for assisting a driver of for a vehicle, comprising:
transmitting light pulses and to receive returns using a light detection and ranging (LiDAR) sensor;
binning the returns from the LiDAR sensor into a plurality of zones;
identifying clusters in the zones;
determining centers and variances of the clusters in x-axis, y-axis, and z-axis directions in the plurality of zones;
identifying a plurality of features based on the centers and the variances;
concatenating the plurality of features into one or more concatenated features; and
detecting at least one of an approaching state, an inside state, and a clear state for a tunnel in response to the one or more concatenated features.

12. The method of claim 11, wherein the plurality of zones include a first zone and a second zone.

13. The method of claim 12, wherein the first zone corresponds to the returns from the LiDAR sensor with values in the z-axis direction less than a predetermined height and the second zone corresponds to the returns with values in the z-axis direction greater than the predetermined height.

14. The method of claim 11, further comprising converting the returns into a Fernet frame.

15. The method of claim 14, further comprising:
detecting pitch of the vehicle; and
compensating the returns from the LiDAR sensor in response to the pitch of the vehicle.

16. The method of claim 13, further comprising using a pre-trained model to detect the approaching state, the inside state, and the clear state in response to the one or more concatenated features.

17. The method of claim 16, further comprising filtering an output of the pre-trained model using a Hidden Markov Model.

18. The method of claim 17, wherein the Hidden Markov Model filters out infeasible state transitions.

19. The method of claim 16, wherein the pre-trained model is configured to detect:
the approaching state in response to the variances of the clusters in the x-axis direction in the second zone being less than a first variance and the variances of the clusters in the z-axis direction in the second zone being greater than a second variance; and
the inside state in response to the variances of the clusters in the x-axis direction in the second zone being greater than a third variance and the variances of the clusters in the z-axis direction in the second zone being less than a fourth variance, wherein the first variance is less than the third variance and the third variance is greater than the fourth variance.

20. The method of claim 16, wherein the pre-trained model is configured to detect a wall in a path of the vehicle in response to the variances in the x-axis direction and the z-axis direction.
